(19) United States
(12) Patent Application Publication
(10) Pub. No.: US 2025/0297915 A1
(43) Pub. Date: Sep. 25, 2025

(54) SHAKING FORCE OPTIMIZATION SYSTEM, SHAKING FORCE OPTIMIZATION METHOD, AND ARITHMETIC DEVICE

(71) Applicant: NIPPON TELEGRAPH AND TELEPHONE CORPORATION, Tokyo (JP)

(72) Inventors: Daiki KOBAYASHI, Tokyo (JP); Toshiki NAKANISHI, Tokyo (JP); Yosuke SAKURADA, Tokyo (JP); Atsushi ARATAKE, Tokyo (JP)

(73) Assignee: NIPPON TELEGRAPH AND TELEPHONE CORPORATION, Tokyo (JP)

(21) Appl. No.: 18/863,768

(22) PCT Filed: May 13, 2022
(86) PCT No.: PCT/JP2022/020284

§ 371 Date: Nov. 7, 2024

(51) Int. Cl. G01M 7/02

(52) U.S. Cl. CPC G01M 7/022; G01M 7/025

(57) ABSTRACT

A excitation force optimization system (1) includes an exciter (10) that excites a structure (40), one or more accelerometers (20) that are installed in the structure (40) and measure vibration of the structure (40) every time the structure (40) is excited, and an arithmetic device (30) that derives a frequency response function on the basis of a measurement value of vibration of the structure (40) and controls an excitation force of the exciter (10) on the basis of the frequency response function.

### TECHNICAL FIELD

The present invention relates to an excitation force optimization system, an excitation force optimization method, and an arithmetic device.

### BACKGROUND ART

Conventionally, when a structure is designed, a natural frequency is measured by modal experiment so that resonance does not occur in the structure. The modal experiment (modal analysis) refers to an experiment of exciting any part of a structure and observing a response at a plurality of portions in order to know a natural frequency characteristic of the structure. The simplest and most common method of modal experiments is experiments with an impulse hammer and accelerometers. However, since the impulse hammer strikes the structure by human power, when the structure is a large structure like a civil engineering structure, the attenuation becomes large, and it becomes extremely difficult to measure an accurate frequency response function. Generally, an accurate frequency response function can be measured by amplifying an excitation force using a modal exciter, but in a large structure such as a civil engineering structure, when a strong excitation force by the modal exciter is applied, nonlinearity appears in the frequency response function, making it difficult to obtain an accurate modal experiment result. The excitation force refers to a force that applies vibration to the structure. The nonlinearity refers to a property that the relationship between the output and the input is not proportional.

For this reason, in the conventional modal experiment, a plurality of exciters with a small excitation force and an accelerometer with high accuracy capable of measuring a small excitation force are used so that the nonlinearity does not appear in the frequency response function. Non Patent Literature 1 describes a technique for more evenly dispersing, in a large structure, a load applied to the structure by using a plurality of exciters that apply a small excitation force to the structure instead of one exciter that applies a large excitation force to the structure.

### CITATION LIST

### Non Patent Literature

Non Patent Literature 1: “Frequently Asked Questions Modal Shakers and Related Topics”, [online], [Searched on Apr. 13, 2022], the Internet <URL: https://www.modalshop.com/filelibrary/Modal%20Shaker%20FAQ%20revA.pdf>

### SUMMARY OF INVENTION

### Technical Problem

However, there is a problem that the use of a highly accurate accelerometer and a plurality of exciters increases the cost.

An object of the present disclosure made in view of such circumstances is to provide an arithmetic device that derives a frequency response function of a structure, and an excitation force optimization system and an excitation force optimization method that optimize an excitation force in deriving the frequency response function of the structure.

### Solution to Problem

In order to solve the above problem, an excitation force optimization system according to the present embodiment is an excitation force optimization system that optimizes an excitation force in deriving a frequency response function of a structure, the excitation force optimization system including: an exciter that excites the structure; one or more accelerometers that are installed in the structure and measure vibration of the structure every time the structure is excited; and an arithmetic device that derives a frequency response function on a basis of a measurement value of vibration of the structure and controls an excitation force of the exciter on a basis of the frequency response function.

In order to solve the above problem, an excitation force optimization method according to the present embodiment is an excitation force optimization method for optimizing an excitation force in deriving a frequency response function of a structure, the method including: a step of amplifying, by an exciter, the excitation force stepwise and repeatedly exciting the structure; a step of measuring, by one or more accelerometers, vibration of the structure excited by the exciter; a step of deriving, by an arithmetic device, a frequency response function on a basis of a measurement value of vibration of the structure; a step of, when a first frequency response function in which a frequency at which a peak of the frequency response function appears varies depending on a number of times of trial is derived and then a second frequency response function in which a frequency at which a peak of the frequency response function equal to or higher than a first threshold appears is constant regardless of the number of times of trial is derived by the arithmetic device, recording the second frequency response function; and a step of, when a third frequency response function in which a peak of a frequency response function that does not exist in the second frequency response function and is equal to or higher than a second threshold appears is derived by the arithmetic device, discarding the third frequency response function and outputting a frequency response function obtained by averaging one or more of the second frequency response functions recorded.

In order to solve the above problem, an arithmetic device according to the present embodiment is an arithmetic device that derives a frequency response function of a structure, the arithmetic device including: a reception unit that receives a measurement value of vibration of the structure from one or more accelerometers; an arithmetic unit that derives the frequency response function on a basis of the measurement value and controls an excitation force of an exciter on a basis of the frequency response function; a display unit that displays and visualizes the frequency response function; and a recording unit that records the frequency response function.

### Advantageous Effects of Invention

With an excitation force optimization system according to the present disclosure, an optimum excitation force for a structure is automatically searched for, and thus an accurate frequency response function can be derived regardless of the skill and know-how of the engineer.

### BRIEF DESCRIPTION OF DRAWINGS

FIG. 1 is a block diagram illustrating a configuration example of an excitation force optimization system according to an embodiment of the present disclosure.

FIG. 2 is a schematic diagram of an excitation force optimization system according to the embodiment of the present disclosure.

FIG. 3 is a graph illustrating a frequency response function in which an excitation force is in an appropriate range.

FIG. 4 is a graph illustrating a frequency response function in which the excitation force is in an excessive range.

FIG. 5 is a block diagram illustrating a configuration example of an arithmetic device according to the embodiment of the present disclosure.

FIG. 6A is a flowchart illustrating an example of an excitation force optimization method executed by an excitation force optimization system according to the embodiment of the present disclosure.

FIG. 6B is a flowchart illustrating an example of the excitation force optimization method executed by the excitation force optimization system according to the embodiment of the present disclosure.

FIG. 7 is a block diagram illustrating a schematic configuration of a computer functioning as the arithmetic device.

### DESCRIPTION OF EMBODIMENTS

Hereinafter, modes for carrying out the present invention will be described in detail with reference to the drawings. The present invention is not limited to the embodiment described below, and various modifications can be made within the scope of the gist of the present invention.

When an excitation force is applied to a large structure by a modal exciter, if an excitation force is not appropriate, nonlinearity is likely to appear in a frequency response function, and an erroneous frequency response function is likely to be measured. As a result of experiments by the inventor, it has been found that when the excitation force is in an appropriate range, the frequency response function has a small attenuation and a sharp rising peak, whereas when the excitation force is in an excessive range, a peak (pseudo peak) of the frequency response function appears in a frequency band in which the frequency response function does not exist. Accordingly, an excitation force optimization system 1 including an arithmetic flow for amplifying the excitation force stepwise (step amplification) and searching for the excitation force in which such a pseudo peak does not appear is proposed below.

### <Excitation Force Optimization System>

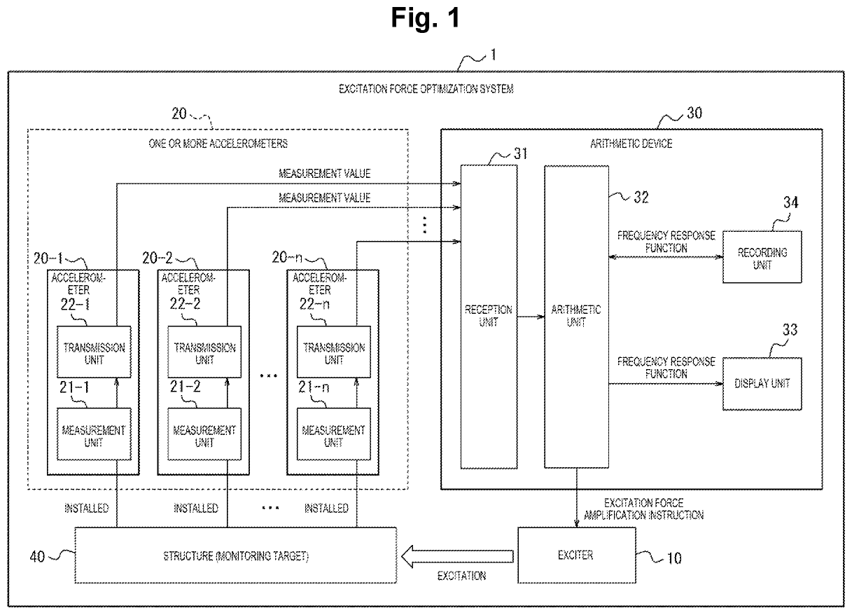

FIG. 1 is a block diagram illustrating a configuration example of an excitation force optimization system 1 according to an embodiment of the present disclosure. As illustrated in FIG. 1, the excitation force optimization system 1 includes an exciter 10, one or more accelerometers 20, and an arithmetic device 30. The excitation force optimization system 1 optimizes the excitation force in deriving the frequency response function of the structure.

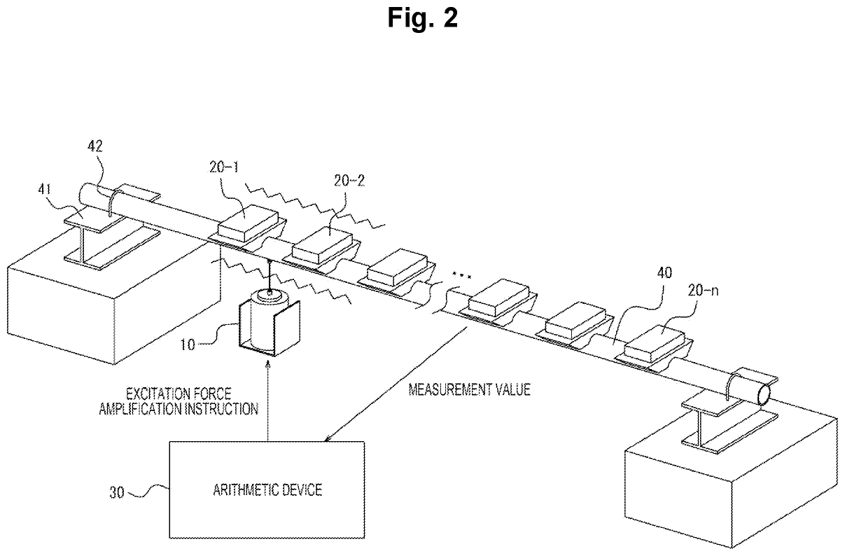

FIG. 2 is a schematic diagram of an excitation force optimization system according to the embodiment of the present disclosure. As illustrated in FIG. 2, a structure (monitoring target) 40 is a tube (tubular structure) and is attached to a support metal 41 at both ends with a U-bolt 42. When the exciter 10 applies an excitation force to the structure 40, the structure 40 vibrates. One or more accelerometers 20 (20-1 to 20-n) are attached to the structure 40, and the one or more accelerometers 20 measure vibration of the structure 40. A measurement value of vibration of the structure 40 is transmitted to the arithmetic device 30 in a wired or wireless manner, and the arithmetic device 30 derives a frequency response function of the structure 40 based on the measurement value.

The exciter 10 excites the structure 40. The exciter 10 first excites the structure 40 with an excessively small excitation force, and then amplifies the excitation force stepwise to repeatedly excite the structure 40. The exciter 10 is a modal exciter. When the excitation force optimization system 1 is activated, the exciter 10 excites the structure 40 with an excessively small excitation force. As will be described later, the exciter 10 amplifies (step amplifies) the excitation force stepwise in accordance with an instruction from the arithmetic device 30 to excite the structure 40.

The one or more accelerometers 20 are installed on the structure 40 and measure vibration of the structure 40 every time the structure 40 is excited. As illustrated in FIG. 1, the one or more accelerometers 20 includes n accelerometers 20-1 to 20-n. The accelerometer 20-1 includes a measurement unit 21-1 that measures vibration of the structure 40 and a transmission unit 22-1 that transmits a measurement value to a reception unit 31 of the arithmetic device 30. The accelerometers 20-2 to 20-n have similar configurations and functions.

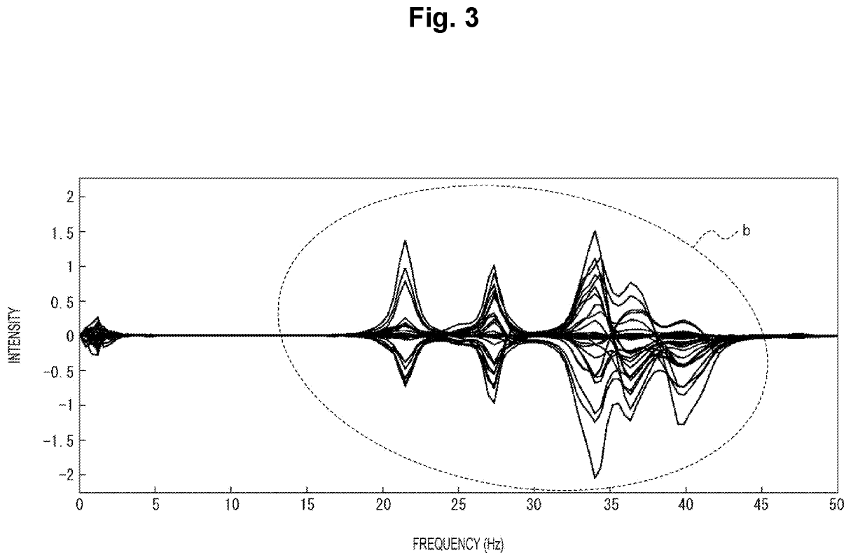

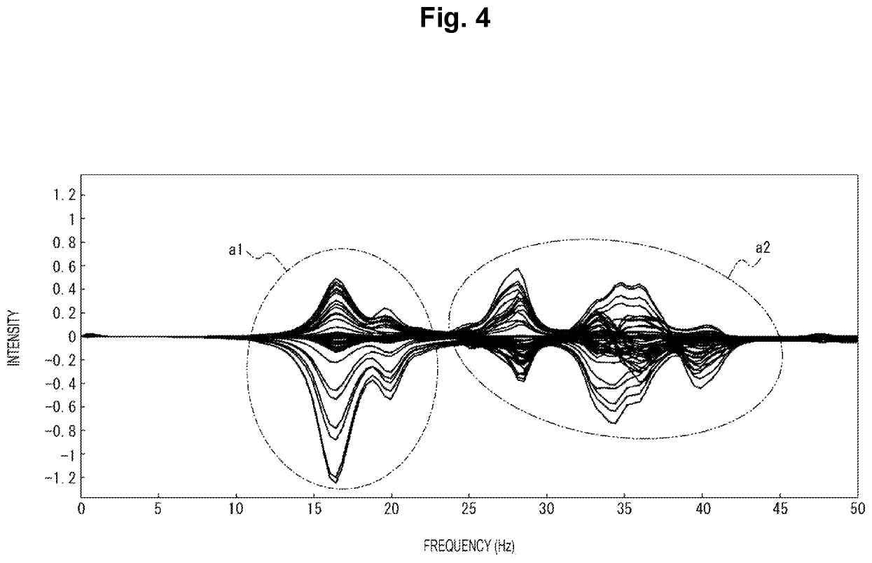

The arithmetic device 30 derives the frequency response function on the basis of the measurement value of the vibration of the structure 40. FIG. 3 is a graph illustrating a frequency response function in which the excitation force is in an appropriate range. FIG. 4 is a graph illustrating a frequency response function in which the excitation force is excessive. FIGS. 3 and 4 illustrate an imaginary part of the frequency response function. As illustrated in FIG. 3, when the excitation force is in an appropriate range, the frequency response function has a sharp peak b with a small attenuation and a rise. On the other hand, as illustrated in FIG. 4, when the excitation force is in an excessive range, the frequency response function expresses a peak a1 (pseudo peak a1) of the frequency response function in the frequency band that does not exist in the frequency response function of FIG. 3, and a peak a2 lacking sharpness of rising appears in the frequency band in which the peak b appears in FIG. 3. In the frequency response functions illustrated in FIGS. 3 and 4, the frequency response functions derived from respective measurement values of the n accelerometers are displayed in an overlapping manner.

The arithmetic device 30 controls the excitation force of the exciter on the basis of the frequency response function. In the present disclosure, trial refers to deriving a frequency response function by amplifying an excitation force in stages. (i) The arithmetic device 30 repeatedly performs the trial a plurality of times (N times), and compares a plurality of frequency response functions recorded for each trial. When it is determined that the frequency response function is a first frequency response function A in which the frequency at which the peak of the frequency response function appears differs (has no reproducibility) depending on the number of times of trial, the arithmetic device 30 amplifies the excitation force. (ii) When it is determined that the frequency response function is a second frequency response function B in which the frequency at which the peak of the frequency response function equal to or higher than a first threshold appears is constant (has reproducibility) regardless of the number of times of trial, the arithmetic device 30 records the second frequency response function B and amplifies the excitation force. (iii) When it is determined that the frequency response function is a third frequency response function C in which the peak of the frequency response function that does not exist in the second frequency response function and is equal to or higher than a second threshold appears, the arithmetic device 30 discards the latest third frequency response function C and outputs the average value of one or more second frequency response functions B.

### <Arithmetic Device>

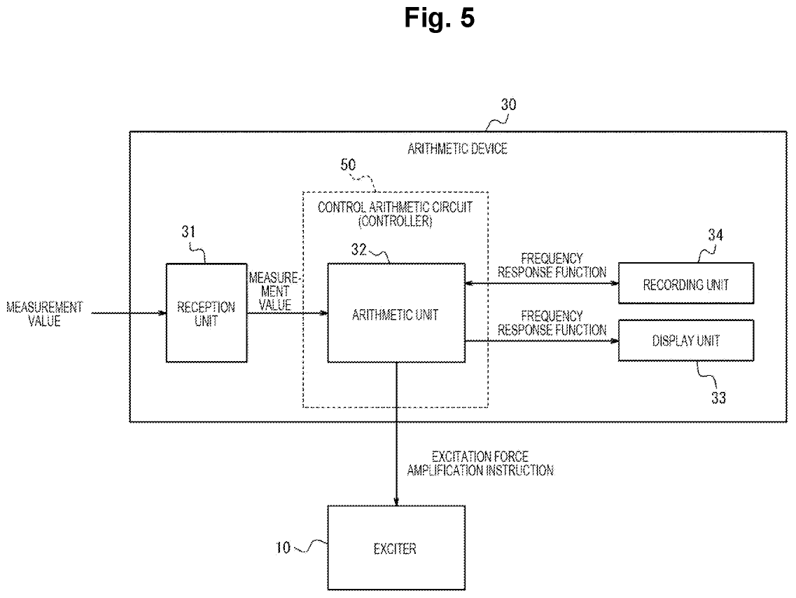

FIG. 5 is a block diagram illustrating a configuration example of an arithmetic device according to the embodiment of the present disclosure. As illustrated in FIG. 5, the arithmetic device 30 includes a reception unit 31, an arithmetic unit 32, a display unit 33, and a recording unit 34. The arithmetic device 30 derives a frequency response function of the structure. The arithmetic unit 32 constitutes a control arithmetic circuit (controller) 50. The control arithmetic circuit 50 may be configured by dedicated hardware such as an application specific integrated circuit (ASIC) or a field-programmable gate array (FPGA), may be configured by a processor, or may be configured to include both.

The reception unit 31 receives measurement values of the vibration frequency of the structure 40 from the transmission units (22-1 to 22-n) of one or more accelerometers 20.

The arithmetic unit 32 derives a frequency response function on the basis of the measurement value of the frequency of the structure 40, and controls the excitation force of the exciter 10 on the basis of the frequency response function. (i) The arithmetic unit 32 repeatedly performs the trial a plurality of times (N times), and compares a plurality of frequency response functions recorded in the recording unit 34 for each trial. When it is determined that the frequency response function is the first frequency response function A in which the frequency at which the peak of the frequency response function appears differs (has no reproducibility) depending on the number of times of trial, the arithmetic unit 32 amplifies the excitation force. (ii) When it is determined that the frequency response function is the second frequency response function B in which the frequency at which the peak of the frequency response function equal to or higher than the first threshold appears is constant (has reproducibility) regardless of the number of times of trial, the arithmetic unit 32 records the second frequency response function B and amplifies the excitation force. (iii) When it is determined that the frequency response function is the third frequency response function C in which the peak of the frequency response function that does not exist in the second frequency response function and is equal to or higher than the second threshold appears, the arithmetic unit 32 discards the latest third frequency response function C and outputs the average value of one or more second frequency response functions B.

The display unit 33 displays and visualizes the frequency response function. The display unit 33 is a display. The display unit 33 displays and visualizes all the frequency response functions on the display in order to determine whether the derived frequency response function is the first frequency response function A, the second frequency response function B, or the third frequency response function C.

The recording unit 34 records the frequency response function. The recording unit 34 outputs the one or more second frequency response functions B to the arithmetic unit 32 in response to a request from the arithmetic unit 32 when the arithmetic unit 32 averages the one or more second frequency response functions B recorded.

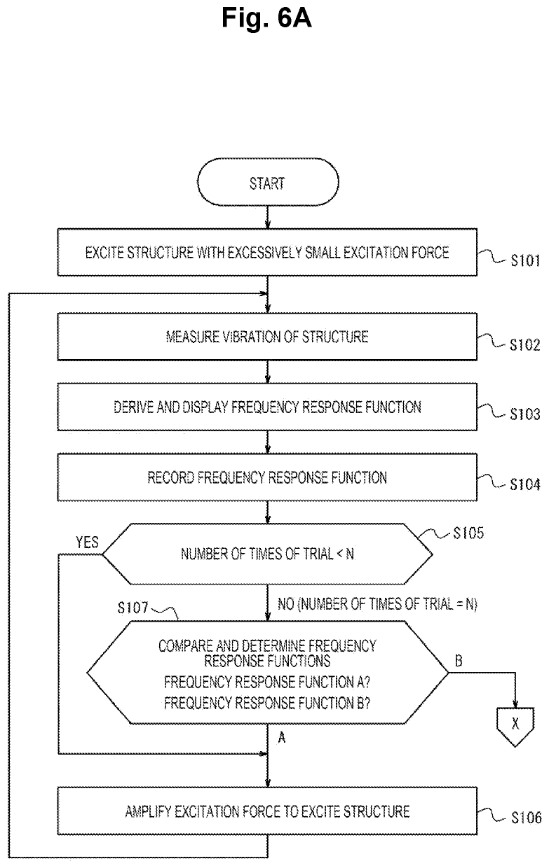

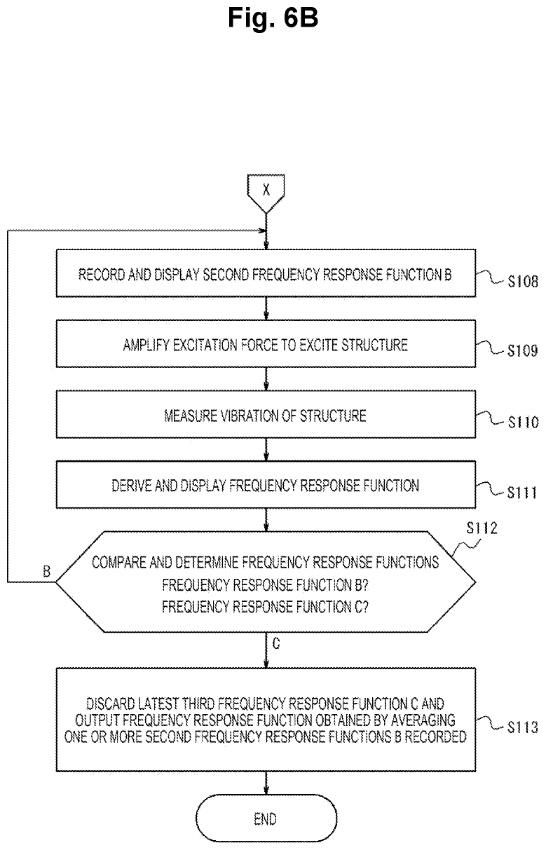

FIGS. 6A and 6B are flowcharts illustrating an example of the excitation force optimization method executed by the excitation force optimization system according to the embodiment of the present disclosure.

In step S101, the exciter 10 excites the structure 40 with an excessively small excitation force.

In step S102, the measurement units 21-1 to 21-n of the one or more accelerometers 20 measure the vibration of the structure 40. The transmission units 22-1 to 22-n of the one or more accelerometers 20 transmit measurement values of vibration of the structure 40 to the reception unit 31 of the arithmetic device 30.

In step S103, the arithmetic unit 32 of the arithmetic device 30 derives a frequency response function on the basis of the received measurement value, and causes the display unit 33 of the arithmetic device 30 to display the derived frequency response function.

In step S104, the recording unit 34 of the arithmetic device 30 records the derived frequency response function.

In step S105, the arithmetic unit 32 of the arithmetic device 30 determines whether or not the number of times of trial has reached N. When the number of times does not reach N, the process proceeds to step S106, and when the number of times reaches N, the process proceeds to step S107.

In step S106, in accordance with an instruction from the arithmetic unit 32 of the arithmetic device 30, the exciter 10 amplifies the excitation force to excite the structure 40. Thereafter, the process returns to step S102, and the measurement units 21-1 to 21-n of the one or more accelerometers 20 measure the vibration of the structure 40.

In step S107, the arithmetic unit 32 of the arithmetic device 30 compares the frequency response functions recorded in the recording unit 34, and determines whether the derived frequency response function is the first frequency response function A or the second frequency response function B. If the frequency response function is the second frequency response function B, the process proceeds to step S108. In the case of the first frequency response function A, the process proceeds to step S106.

In step S108, the arithmetic unit 32 of the arithmetic device 30 records the derived second frequency response function B in the recording unit 14 and displays the second frequency response function B on the display unit 33.

In step S109, in accordance with an instruction from the arithmetic unit 32 of the arithmetic device 30, the exciter 10 amplifies the excitation force stepwise to excite the structure 40.

In step S110, the measurement units 21-1 to 21-n of the one or more accelerometers 20 measure the vibration of the structure 40. The transmission units 22-1 to 22-n of the one or more accelerometers 20 transmit measurement values of vibration of the structure 40 to the reception unit 31 of the arithmetic device 30.

In step S111, the arithmetic unit 32 of the arithmetic device 30 derives a frequency response function on the basis of the received measurement value, and causes the display unit 33 of the arithmetic device 30 to display the derived frequency response function.

In step S112, the arithmetic unit 32 of the arithmetic device 30 determines whether the derived frequency response function is the second frequency response function B or the third frequency response function C. If the frequency response function is the second frequency response function B, the process proceeds to step S108. In the case of the third frequency response function C, the process proceeds to step S113.

In step S113, the latest third frequency response function C is discarded, and a frequency response function obtained by averaging one or more second frequency response functions B recorded in the recording unit 34 is output.

In a modal experiment of a large structure, nonlinearity is likely to appear due to the influence of an excitation force, and an erroneous frequency response function is likely to be measured. For this reason, in order to obtain an accurate frequency response function, it is necessary to excite the large structure by controlling the excitation force to an optimum magnitude. The excitation force optimization system 1 according to the present disclosure has a system configuration that adjusts the excitation force by feeding back a stepwise amplification instruction of the excitation force to the exciter 10 on the basis of information of the frequency response function derived from the measurement value of vibration of the large structure by one or more accelerometers 20. With the excitation force optimization system 1, since the system automatically searches for the optimum excitation force, an accurate frequency response function can be derived regardless of the skill and know-how of the engineer.

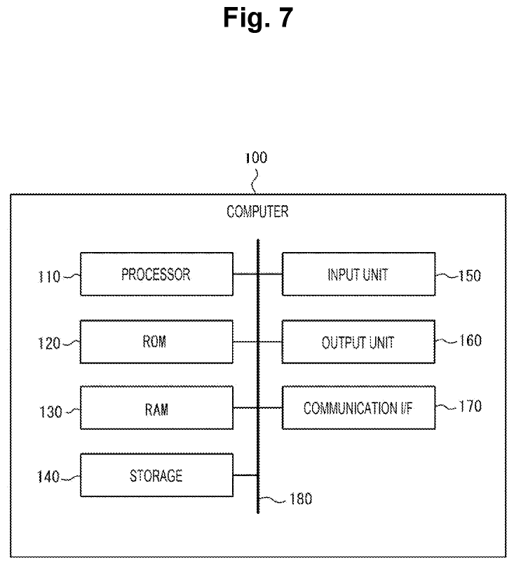

In order to cause the arithmetic device 30 to function, it is also possible to use a computer capable of executing a program instruction. FIG. 7 is a block diagram illustrating a schematic configuration of a computer that functions as the arithmetic device 30. Here, the computer that functions as the arithmetic device 30 may be a general-purpose computer, a dedicated computer, a workstation, a personal computer (PC), an electronic note pad, or the like. The program instruction may be a program code, a code segment, or the like, for executing a necessary task.

As illustrated in FIG. 7, a computer 100 includes a processor 110, a read only memory (ROM) 120, a random access memory (RAM) 130, and a storage 140 as storage units, an input unit 150, an output unit 160, and a communication interface (I/F) 170. The respective constituents are communicatively connected to each other via a bus 180.

The ROM 120 stores various kinds of programs and various kinds of data. The RAM 130 temporarily stores a program or data as a working area. The storage 140 is constituted by a hard disk drive (HDD) or a solid state drive (SSD) and stores various kinds of programs including an operating system and various kinds of data. In the present disclosure, a program according to the present disclosure is stored in the ROM 120 or the storage 140.

Specifically, the processor 110 is a central processing unit (CPU), a micro processing unit (MPU), a graphics processing unit (GPU), a digital signal processor (DSP), a system on a chip (SoC), or the like, and may be constituted by the same or different types of plurality of processors. The processor 110 reads a program from the ROM 120 or the storage 140 and executes the program by using the RAM 130 as a working area to perform control of each of the above-described components and various kinds of arithmetic processing. Note that at least part of these processing content may be implemented by hardware.

The program may be recorded in a recording medium readable by the arithmetic device 30. By using such a recording medium, the program can be installed in the arithmetic device 30. Here, the recording medium on which the program is recorded may be a non-transitory recording medium. The non-transitory recording medium is not particularly limited, but may be, for example, a CD-ROM, a DVD-ROM, a Universal Serial Bus (USB) memory, or the like. In addition, the program may be downloaded from an external device via a network.

With regard to the above embodiment, the following supplementary notes are further disclosed.

(Supplement 1) An excitation force optimization system that optimizes an excitation force in deriving a frequency response function of a structure, the excitation force optimization system including: an exciter that excites the structure; one or more accelerometers that are installed in the structure and measure vibration of the structure every time the structure is excited; and an arithmetic device that derives a frequency response function on a basis of a measurement value of vibration of the structure and controls an excitation force of the exciter on a basis of the frequency response function.

(Supplement 2) The excitation force optimization system according to supplementary note 1, in which the arithmetic device amplifies the excitation force when the frequency response function is a first frequency response function in which a frequency at which a peak of the frequency response function appears varies depending on a number of times of trial, and when the frequency response function is a second frequency response function in which a frequency at which a peak of the frequency response function equal to or higher than a first threshold appears is constant regardless of the number of times of trial, the second frequency response function is recorded and the excitation force is amplified, and when the frequency response function is a third frequency response function in which a peak of a frequency response function that does not exist in the second frequency response function and is equal to or higher than a second threshold appears, the third frequency response function is discarded, and an average value of the second frequency response function is output.

(Supplement 3) An arithmetic device that derives a frequency response function of a structure, the arithmetic device including: a receiver that receives a measurement value of vibration of the structure from one or more accelerometers; a controller that derives the frequency response function on a basis of the measurement value and controls an excitation force of an exciter on a basis of the frequency response function; a display that displays and visualizes the frequency response function; and a memory that records the frequency response function.

(Supplement 4) The arithmetic device according to supplementary note 3, in which the controller amplifies the excitation force when the frequency response function is a first frequency response function in which a frequency at which a peak of the frequency response function appears varies depending on a number of times of trial, and when the frequency response function is a second frequency response function in which a frequency at which a peak of the frequency response function equal to or higher than a first threshold appears is constant regardless of the number of times of trial, the second frequency response function is recorded and the excitation force is amplified, and when the frequency response function is a third frequency response function in which a peak of a frequency response function that does not exist in the second frequency response function and is equal to or higher than a second threshold appears, the third frequency response function is discarded, and an average value of the second frequency response function is output.

(Supplement 5) An excitation force optimization method for optimizing an excitation force in deriving a frequency response function of a structure, the method including: amplifying, by an exciter, the excitation force stepwise and repeatedly exciting the structure; measuring, by one or more accelerometers, vibration of the structure excited by the exciter; deriving, by an arithmetic device, a frequency response function on a basis of a measurement value of vibration of the structure; when a first frequency response function in which a frequency at which a peak of the frequency response function appears varies depending on a number of times of trial is derived and then a second frequency response function in which a frequency at which a peak of the frequency response function equal to or higher than a first threshold appears is constant regardless of the number of times of trial is derived by the arithmetic device, recording the second frequency response function; and when a third frequency response function in which a peak of a frequency response function that does not exist in the second frequency response function and is equal to or higher than a second threshold appears is derived by the arithmetic device, discarding the third frequency response function and outputting a frequency response function obtained by averaging one or more of the second frequency response functions recorded.

Although the above-described embodiments have been described as representative examples, it is apparent to those skilled in the art that many modifications and substitutions can be made within the spirit and scope of the present disclosure. Thus, it should not be understood that the present invention is limited by the above-described embodiments, and various modifications or changes can be made without departing from the scope of the claims. For example, a plurality of configuration blocks described in the configuration diagram of the embodiment can be combined into one, or one configuration block can be divided.

### REFERENCE SIGNS LIST

1 Excitation force optimization system
10 Exciter
20 One or more accelerometers
20-1 to 20-n Accelerometer
21-1 to 21-n Measurement unit
22-1 to 22-n Transmission unit
30 Arithmetic device
31 Reception unit (receiver)
32 Arithmetic unit
33 Display unit (display)
34 Recording unit (memory)
40 Structure (monitoring target)
41 Support metal
42 U-bolt
50 Control arithmetic circuit (controller)
100 Computer
110 Processor
120 ROM
130 RAM
140 Storage
150 Input unit
160 Output unit
170 Communication interface (I/F)
180 Bus

1. An excitation force optimization system that optimizes an excitation force in deriving a frequency response function of a structure, the excitation force optimization system comprising: an exciter that excites the structure; one or more accelerometers that are installed in the structure and measure vibration of the structure every time the structure is excited; and an arithmetic device that derives a frequency response function on a basis of a measurement value of vibration of the structure and controls an excitation force of the exciter on a basis of the frequency response function.

2. The excitation force optimization system according to claim 1, wherein the arithmetic device amplifies the excitation force when the frequency response function is a first frequency response function in which a frequency at which a peak of the frequency response function appears varies depending on a number of times of trial, and when the frequency response function is a second frequency response function in which a frequency at which a peak of the frequency response function equal to or higher than a first threshold appears is constant regardless of the number of times of trial, the second frequency response function is recorded and the excitation force is amplified, and when the frequency response function is a third frequency response function in which a peak of a frequency response function that does not exist in the second frequency response function and is equal to or higher than a second threshold appears, the third frequency response function is discarded, and an average value of the second frequency response function is output.

3. An arithmetic device that derives a frequency response function of a structure, the arithmetic device comprising: a reception unit that receives a measurement value of vibration of the structure from one or more accelerometers; an arithmetic unit that derives the frequency response function on a basis of the measurement value and controls an excitation force of an exciter on a basis of the frequency response function; a display unit that displays and visualizes the frequency response function; and a recording unit that records the frequency response function.

4. The arithmetic device according to claim 3, wherein the arithmetic unit amplifies the excitation force when the frequency response function is a first frequency response function in which a frequency at which a peak of the frequency response function appears varies depending on a number of times of trial, and when the frequency response function is a second frequency response function in which a frequency at which a peak of the frequency response function equal to or higher than a first threshold appears is constant regardless of the number of times of trial, the second frequency response function is recorded and the excitation force is amplified, and when the frequency response function is a third frequency response function in which a peak of a frequency response function that does not exist in the second frequency response function and is equal to or higher than a second threshold appears, the third frequency response function is discarded, and an average value of the second frequency response function is output.

5. An excitation force optimization method for optimizing an excitation force in deriving a frequency response function of a structure, the method comprising:
amplifying, by an exciter, the excitation force stepwise and repeatedly exciting the structure;
measuring, by one or more accelerometers, vibration of the structure excited by the exciter;
deriving, by an arithmetic device, a frequency response function on a basis of a measurement value of vibration of the structure;
when a first frequency response function in which a frequency at which a peak of the frequency response function appears varies depending on a number of times of trial is derived and then a second frequency response function in which a frequency at which a peak of the frequency response function equal to or higher than a first threshold appears is constant regardless of the number of times of trial is derived by the arithmetic device, recording the second frequency response function; and
when a third frequency response function in which a peak of a frequency response function that does not exist in the second frequency response function and is equal to or higher than a second threshold appears is derived by the arithmetic device, discarding the third frequency response function and outputting a frequency response function obtained by averaging one or more of the second frequency response functions recorded.
